(19) United States
(12) Patent Application Publication
(10) Pub. No.: US 2025/0384870 A1
(43) Pub. Date: Dec. 18, 2025

(54) CONTROLLING DIALOGUE USING CONTEXTUAL INFORMATION FOR STREAMING SYSTEMS AND APPLICATIONS

(71) Applicant: NVIDIA Corporation, Santa Clara, CA (US)

(72) Inventors: Seyed Danial Mohseni Taheri, Santa Clara, CA (US); Oluwatobi Olabiyi, Falls Church, VA (US); Ehsan Hosseini Asl, San Jose, CA (US); Vinay Raman, San Jose, CA (US)

(21) Appl. No.: 18/746,579

(22) Filed: Jun. 18, 2024

(51) Int. Cl. G10L 13/08; G06F 40/40; G06T 13/20; G06T 13/40

(52) U.S. Cl. CPC G10L 13/08; G06F 40/40; G06T 13/205; G06T 13/40

(57) ABSTRACT

In various examples, controlling dialogue using contextual information for conversational artificial intelligence (AI) systems and applications is described herein. Systems and methods are disclosed that use various sources of contextual information, along with textual inputs (e.g., queries), to generate textual outputs (e.g., responses) associated with a dialogue between a user (e.g., a user's character) and another character (e.g., a non-playable character) of an application. For instance, the contextual information may be stored in one or more databases, such as one or more vector databases, and/or in a specific form, such as embeddings that represent the contextual information. One or more language models may then process a textual input and/or at least a portion of the stored contextual information in order to generate a textual output. This textual output may then be used to generate speech that is output by the other character.

### BACKGROUND

Many applications, such as gaming applications, interactive applications, communications applications, multimedia applications, and/or the like, use animated characters or digital avatars that interact with users of the applications and/or other animated characters within the applications. For instance, while playing a gaming application, a user's character may interact with another character located within the gaming environment such as through a dialogue between the characters. For example, the user may input a query that the user's character is to communicate to the other character, such as a query that includes a request for information. The gaming application may then process the query from the user in order to generate a response to the query, such as a response that includes the requested information. Additionally, the gaming application may provide the response in the form of speech that is output by the other character and back towards the user's character. This process may then continue to repeat during the dialogue between the user's character and the other character.

Currently, systems that provide such dialogue in applications may use sets of responses for different queries that may be asked by users. For instance, if the query from the user is for information about an item, then the current systems may search through responses that include different information about the item and select one of the responses that is most relevant to the query. However, by merely selecting a response from a set of response, the current systems may be unable to answer certain queries from the users, such as queries for which the set of responses does not include an accurate response. For example, if the query from the user requires knowledge about a current context associated with the application, such as previous tasks that have been performed by the user and/or a current task that the user is attempting to complete, then the response may not be relevant to the context. Additionally, merely selecting a response from a set of response may cause the other character to seem less “human-like” and/or interactive to the user.

### SUMMARY

Embodiments of the present disclosure relate to controlling dialogue using contextual information for streaming systems and applications. Systems and methods are disclosed that use various sources of contextual information, along with textual inputs (e.g., queries), to generate textual outputs (e.g., responses) associated with a dialogue between a user (e.g., a user's character) and another character (e.g., a non-playable character) of an application. For instance, the contextual information may be stored in one or more databases, such as one or more vector databases, and/or in a specific form, such as embeddings that represent the contextual information. Additionally, the contextual information may include text (e.g., documents, etc.), images, videos, and/or any other source of information associated with the application. As such, to generate a textual output, the textual input and/or additional contextual information associated with a current state of the application may be used to retrieve at least a portion of the stored contextual information from the database(s). One or more language models may then process the textual input and/or the retrieved portion of the stored contextual information in order to generate the textual output.

In contrast to conventional systems, such as those described above, in some embodiments, the systems of the present disclosure may store the additional contextual information associated with the application and then use the additional contextual information when generating textual outputs associated with speech. As such, the systems of the present response may generate responses that are more relevant to the current state of the application and/or are more accurate with regard to textual inputs, such as queries. Additionally, since the systems of the present disclosure are able to generate such improved responses, the characters that are outputting the speech may seem more human-like (e.g., more anthropomorphic) to users of the application, such as by providing the response that are more relevant to the current state of the application and/or change based on various circumstances associated with the application.

### BRIEF DESCRIPTION OF THE DRAWINGS

The present systems and methods for controlling dialogue using contextual information for streaming systems and applications are described in detail below with reference to the attached drawing figures, wherein:

FIG. 1 illustrates an example data flow diagram for a process of controlling dialogue within an application using contextual information, in accordance with some embodiments of the present disclosure;

FIG. 2 illustrates an example of generating embeddings associated with sources of contextual information corresponding to an application, in accordance with some embodiments of the present disclosure;

FIG. 3 illustrates an example of searching through one or more databases in order to identify embeddings that are related to an input, in accordance with some embodiments of the present disclosure;

FIG. 4 illustrates an example of filtering embeddings in order to identify embeddings that are more related to an input, in accordance with some embodiments of the present disclosure;

FIG. 5 illustrates an example of generating a prompt using an input and textual information from one or more sources, in accordance with some embodiments of the present disclosure;

FIG. 6 illustrates an example of determining one or more textual embeddings that are associated with one or more image embeddings, in accordance with some embodiments of the present disclosure;

FIG. 7 illustrates an example of using one or more language models to generate an output, in accordance with some embodiments of the present disclosure;

FIG. 8 illustrates a flow diagram showing a method for controlling dialogue using contextual information associated with an application, in accordance with some embodiments of the present disclosure;

FIG. 9 illustrates a flow diagram showing another method for controlling dialogue using contextual information associated with an application, in accordance with some embodiments of the present disclosure;

FIG. 10 illustrates a flow diagram showing a method for identifying contextual information for use in generating speech associated with an application, in accordance with some embodiments of the present disclosure;

FIG. 11 is a block diagram of an example content streaming system suitable for use in implementing some embodiments of the present disclosure;

FIG. 12 is a block diagram of an example computing device suitable for use in implementing some embodiments of the present disclosure; and

FIG. 13 is a block diagram of an example data center suitable for use in implementing some embodiments of the present disclosure.

### DETAILED DESCRIPTION

Systems and methods are disclosed related to controlling dialogue using contextual information for streaming systems and applications. For instance, a system(s) may generate, retrieve, receive, and/or obtain sources of contextual information associated with an application. As described herein, an application may include, but is not limited to, a gaming application, an interactive application (which may include one or more of these other types of applications), a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, an entertainment application (e.g., a show, a movie, etc.), or any other type of application. Additionally, the sources of contextual information may include, but are not limited to, one or more textual sources (e.g., documents, guides, walkthroughs, descriptions, articles, and/or any other textual information), one or more images, one or more videos, one or more instances of audio, and/or any other source of information.

For a first example, at least a portion of the sources of textual information may include textual sources describing settings, locations within an environment (e.g., levels, stadiums, buildings, areas, towns, etc.), tasks to perform (e.g., items to retrieve, characters to meet, locations to travel, etc.), biographies associated with characters, actions associated with characters, and/or any other textual information associated with the application. As described herein, a biography associated with a character may include, but is not limited to, characteristics associated with the character (e.g., profession, relationships, personality traits, etc.), past communications (e.g., past speech output by the character, etc.), current circumstances (e.g., current interactions with other characters, a current location, current objectives, etc.), and/or any other information associated with the character. For a second example, at least a portion of the sources of contextual information may include one or more images from the application, one or more images depicting objects (e.g., characters, items, locations, etc.) from the application, one or more images depicting one or more maps associated with the application, one or more images depicting information associated with the application (e.g., walkthroughs, hints, expert information, etc.), and/or any other visual information associated with the application. Still, for a third example, at least a portion of the contextual information may include biographical information associated with a user of the application.

In some examples, the system(s) may then preprocess at least a portion of the sources of contextual information in order to generate processed information associated with the application. For a first example, and for a source of contextual information that includes text, the system(s) may process the text in order to segment the text into different portions (e.g., chunks) of text, such as words, sentences, paragraphs, pages, sections, and/or the like associated with the text. For a second example, and for a source of contextual information that includes a video, the system(s) may process the video in order to segment the video into images and/or groups of images. Still, for a third example, and for a source of contextual information that includes an image, the system(s) may process the image in order to segment portions of the image, such as portions of the image that represent specific objects, locations, and/or the like associated with the application.

In some examples, the system(s) may then further process the sources of contextual information (e.g., the processed information) using one or more techniques in order to store the contextual information in one or more databases. For instance, the system(s) may process the sources of contextual information using one or more embedding models in order to generate embeddings associated with the contextual information. As described herein, an embedding may include, but is not limited to, a textual embedding associated with at least a portion of text, an image embedding associated with at least a portion of an image, a mixed textual and visual embedding associated with an image that includes text and/or an image that is associated with text, and/or any other type of embedding (e.g., multimodal embedding, etc.). The system(s) may then store the embeddings in one or more databases, such as one or more vector databases.

Additionally, in some examples, the system(s) may generate additional metadata associated with the embeddings. For instance, and for an embedding, the system(s) may generate metadata indicating an identifier for an object (e.g., a character, an item, etc.) associated with the embedding, an identifier for an event associated with the embedding, an identifier for a location associated with the embedding, an identifier for a level and/or other progress indicator associated with the embedding, a timestamp associated with the embedding (e.g., a timestamp indicating when the contextual information was generated), and/or any other information associated with the embedding. In examples where the system(s) generates the metadata, the system(s) may store the metadata in database(s) and/or in association with the embeddings.

In some examples, such as during a session associated with the application, the system(s) may generate, retrieve, receive, and/or obtain additional sources of contextual information associated with the application. As described herein, the additional sources of contextual information may include one or more images associated with the application (e.g., images presented by a client device), one or more previous textual inputs processed by the system(s) (described below), one or more previous textual outputs associated with the previous textual input(s), and/or any other contextual information that may be generated during the session. The system(s) may then process the additional sources of contextual information, using one or more similar processes as the initial sources of contextual information, in order to generate one or more additional embeddings for storage in the database(s). In other words, the system(s) may continue updating the stored contextual information such that the database(s) stores the most updated contextual information for use for later processing.

For instance, the system(s) may receive data representing an input from the user. As described herein, the data may include, but is not limited to, audio data representing speech associated with the input, text data representing text associated with the input, image data representing one or more images depicting the input, and/or any other type of data. Additionally, the input may include, but is not limited to, a query, a request, an instruction, a suggestion, an observation, and/or any other type of input that may be provided with respect to the application. In some examples, the system(s) may then process the data in order to generate text that represents the input, which may be referred to as a “textual input.” For a first example, if the data includes audio data representing user speech corresponding to a query from the user, then the system(s) may generate a textual input that represents one or more words from the query. For a second example, if the data includes text data representing text corresponding to a request from the user, then the system(s) may generate a textual input that represents one or more words from the text. For a third example, if the data includes visual data representing user gestures corresponding to a query from the user, then the system(s) may generate a textual input that represents one or more words from the query.

In some examples, the system(s) may then process the textual input in order to generate one or more search embeddings associated with the textual input, such as by using the embedding model(s). Additionally, in some examples, the system(s) may process one or more additional sources of contextual information, such as one or more images associated with the session of the application, in order to generate one or more additional search embeddings associated with the textual input. For example, the image(s) may include one or more images that are being displayed by the client device and during the session. As described in more detail herein, the system(s) may then search through embeddings stored in the database(s) using this search embedding(s) in order to identify one or more stored embeddings that are related to the search embedding(s). Additionally, the identified embedding(s) may include one or more textual embeddings, one or more image embeddings, and/or any other type of embedding.

In some examples, the system(s) may then filter the identified embedding(s) using one or more filters, such as to identify contextual information that is more relevant to the textual input. For a first example, if the identified embeddings include embeddings associated with multiple characters of the application, then the system(s) may filter the embeddings using a filter associated with a specific character in order to identify a portion of the embeddings that are related to the specific character. For a second example, if the identified embeddings include embeddings that are associated with multiple levels of the application, then the system(s) may filter the embeddings using one or more filters associated with one or more levels (e.g., the current level along with one or more preceding levels) in order to identify a portion of the embeddings that are related to the level(s). Still, for a third example, if the identified embeddings include embeddings that are associated multiple dialogues between the user and a character, then the system(s) may filter the embeddings using a filter associated with a current dialogue in order to identify a portion of the embeddings that are related to the current dialogue. While these are just a few example filters that may be used to further process the embeddings, in other examples, and as described more herein, the system(s) may use additional and/or alternative filters.

The system(s) may then use the identified embeddings to generate input data to be applied to one or more language models. For instance, in some examples, if the system(s) identifies one or more textual embeddings, the system(s) may then retrieve one or more sources of textual information corresponding to the textual embedding(s). The system(s) may then use the textual information along with the textual input to generate a prompt for the language model(s). Additionally, or alternatively, in some examples, if the system(s) identifies one or more image embeddings, the system(s) may then process the image embedding(s) using one or more components (e.g., an adapter, a model, etc.) that are configured to retrieve and/or generate one or more textual embeddings associated with the image embedding(s). The system(s) may then generate the input data using the prompt, the textual embedding(s), and/or text associated with the textual embedding(s). For instance, the system(s) may generate one or more input tokens using the prompt, the textual embedding(s), and/or the text associated with the textual embedding(s), where the input data represents the input token(s).

The system(s) may then apply at least a portion of the input data to the language model(s) for processing. For instance, based at least on processing the at least the portion of the input data, the language model(s) may generate and/or output data representing text that is associated with the textual input, where the text may be referred to as a “textual output.” For instance, and as described herein, the textual output may include, but is not limited to, a response, information, a recommendation, a suggestion, an instruction, and/or any other type of output associated with the textual input. In some examples, the output data may represent one or more tokens that represent the textual output. In such examples, the system(s) may process the output token(s) in order to generate the textual output associated with the textual input.

In some examples, the system(s) may then process the textual output, such as by using one or more talk-to-speech (TTS) models, in order to generate audio data representing speech. As described herein, in some examples, the speech may include one or more words associated with the textual output. The system(s) may then cause the character associated with the application to output the speech, such as by sending the audio data to the client device. Additionally, the system(s) may continue to perform these processes as the dialogue between the user of the application (e.g., the user's character) and the other character of the application continues. As such, by performing one or more of these processes described herein, the system(s) is able to generate speech for the character that is more human-like when providing responses by taking into contextual information associated with the application.

For example, consider a situation where a user's character just finished fighting in a battle and is now at another location communicating with a character. During the dialogue between the user's character and the other character, the user's character may ask a query, such as a location of a specific object. As such, by performing at least a portion of the processes described herein, the system(s) may generate a response to the query using both the query and contextual information associated with the battle. This way, the response may be more sympathetic as compared to a response that does not consider the fact that the user's character just finished a battle.

For another example, consider a situation where a user's character performs a first conversation with a character and then later performs a second conversation with the same character. Additionally, during the second conversation, the user's character may ask a query that references the first conversation, such as a query that asks about one or more topics from the first conversation. As such, by performing at least a portion of the processes described herein, the system(s) may generate a response to the query using both the query and contextual information associated with the first conversation. This way, the response may include additional information from the first conversation that would not be included without the contextual information associated with the first conversation.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems that provides one or more cloud gaming applications; systems for performing generative AI operations, systems implemented at least partially using cloud computing resources, and/or other types of systems.

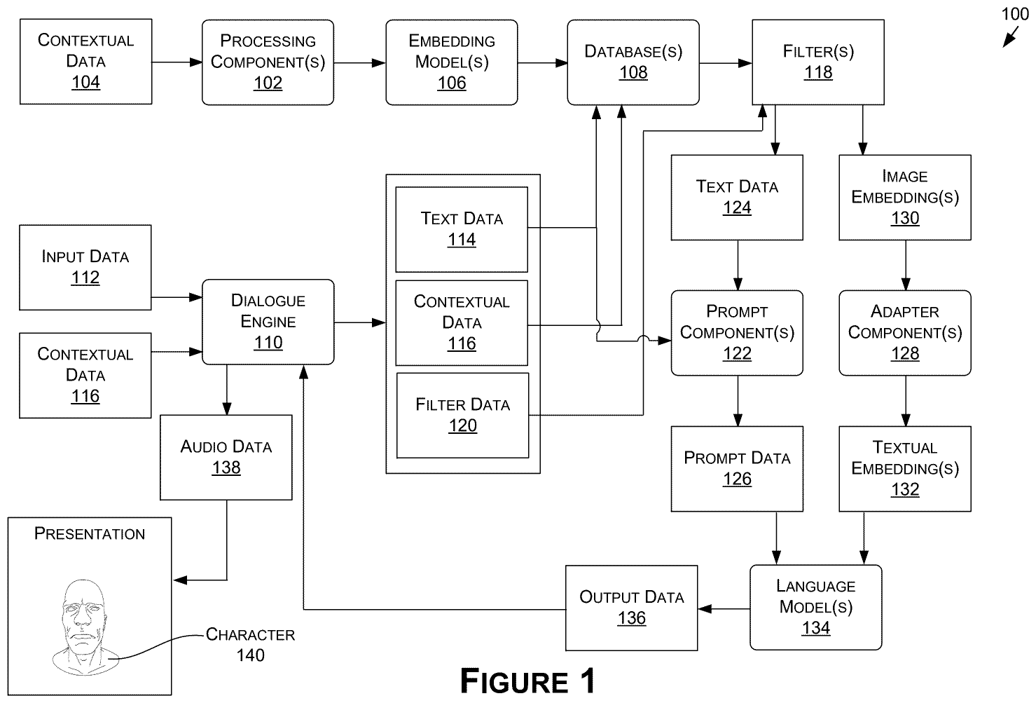

With reference to FIG. 1, FIG. 1 illustrates an example data flow diagram for a process 100 of controlling dialogue within an application using contextual information, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more processing components 102 receiving contextual data 104 representing sources of contextual information associated with an application. As described herein, an application may include, but is not limited to, a gaming application, an interactive application (which may include one or more of these other types of applications), a multimedia application (e.g., a video streaming application, a music streaming application, a voice streaming application, a multimedia streaming application that includes both audio and video, etc.), a communications application (e.g., a video conferencing application, etc.), an educational application, a collaborative content creation application, an entertainment application (e.g., a show, a movie, etc.), or any other type of application. Additionally, the sources of contextual information may include, but is not limited to, one or more textual sources (e.g., documents, guides, walkthroughs, descriptions, articles, and/or any other textual source) associated with the application, one or more images associated with the application, one or more videos associated with the application, one or more instances of sound associated with the application, and/or any other type of data.

For a first example, at least a portion of the contextual data 104 may represent textual sources that include text describing settings, locations within an environment (e.g., levels, stadiums, buildings, areas, towns, etc.), tasks to perform (e.g., items to retrieve, characters to meet, locations to travel, etc.), biographies associated with characters, actions associated with characters, and/or any other textual information associated with the application. As described herein, a biography associated with a character may include, but is not limited to, characteristics associated with the character (e.g., a profession, relationships, personality traits, etc.), past communications (e.g., past speech output by the character, past dialogues associated with the character, etc.), current circumstances (e.g., current interactions with other characters, a current location, current objectives, etc.), and/or any other information associated with the character. For a second example, at least a portion of the contextual data 104 may represent one or more images from the application, one or more images depicting objects (e.g., characters, items, locations, etc.) from the application, one or more images depicting one or more maps associated with the application, one or more images (e.g., a video) depicting information associated with the application (e.g., walkthroughs, hints, expert information, etc.), and/or any other visual information associated with the application. For a third example, at least a portion of the contextual data 104 may represent biographical information associated with a user of the application.

The process 100 may then include the processing component(s) 102 processing at least a portion of the contextual data 104 in order to generate processed contextual data associated with the application. As described herein, in some examples, the processing component(s) 102 may process the contextual data 104 using one or more segmentation techniques. For a first example, if the contextual data 104 represents a source that includes text, the processing component(s) 102 may process the text in order to segment the text into different portions (e.g., chunks) of text, such as words, sentences, paragraphs, pages, sections, and/or the like associated with the text. For a second example, if the contextual data 104 represents a video, the processing component(s) 102 may process the video in order to segment the video into images and/or groups of images. Still, for a third example, if the contextual data 104 represents an image, the processing component(s) 102 may process the image in order to segment portions of the image, such as portions of the image that represent specific objects, locations, text, and/or the like associated with the application. While these are just a few example techniques of how the processing component(s) 102 may process the contextual data 104, in other examples, the processing component(s) 102 may process the contextual data 104 using additional and/or alternative techniques.

The process 100 may then include one or more embedding models 106 processing at least a portion of the contextual data 104 (e.g., the processed contextual data 104) and, based at least on the processing, generating embeddings associated with the contextual data 104. As described herein, an embedding may include, but is not limited to, a textual embedding associated with at least a portion of text, an image embedding associated with at least a portion of an image, a mixed textual and visual embedding associated with an image that includes text and/or an image that is associated with text, and/or any other type of embedding (e.g., multimodal embedding). The embeddings generated using the embedding model(s) 106 may then be stored in one or more databases 108, such as one or more vector databases (and/or any other type of database). In some examples, the sources of contextual information may also be stored in the database(s) 108 and/or in association with the embeddings.

Additionally, in some examples, the embedding model(s) 106 (and/or another component, such as a dialogue engine 110) may generate additional metadata associated with the embeddings. For instance, and for an embedding, the embedding model(s) 106 may generate metadata indicating an identifier for an object (e.g., a character, an item, etc.) associated with the embedding, an identifier associated with an event corresponding to the embedding, an identifier for a location associated with the embedding, an identifier for a level and/or other progress indicator associated with the embedding, a timestamp associated with the embedding (e.g., a timestamp indicating when the contextual data 104 was generated), and/or any other information associated with the embedding. This additional metadata may then also be stored in association with the embeddings and/or within the database(s) 108. As will be described in more detail herein, at least a portion of this metadata may later be used when identifying contextual data 104, such as during a filtering process.

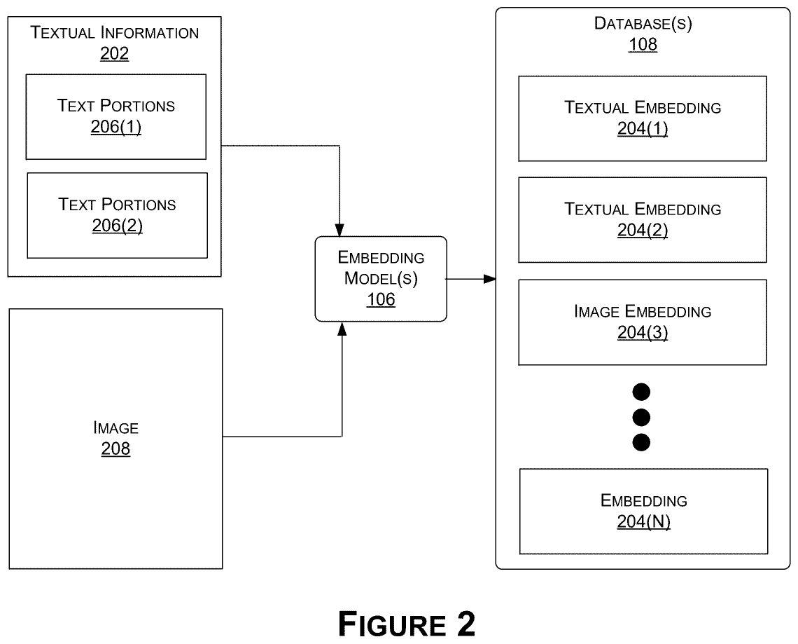

For instance, FIG. 2 illustrates an example of generating embeddings associated with sources of contextual information corresponding to an application, in accordance with some embodiments of the present disclosure. As shown, the embedding model(s) 106 may process contextual data (e.g., contextual data 104) representing a source of textual information 202 (e.g., a document, etc.) associated with the application. Based at least on the processing, the embedding model(s) 106 may generate a first textual embedding 204(1) associated with a first portion 206(1) of text and a second textual embedding 204(2) associated with a second portion 206(2) of the text. The embedding model(s) 106 may then process contextual data (e.g., contextual data 104) representing an image 208 associated with the application. Based at least on the processing, the embedding model(s) 106 may generate an image embedding 204(3) associated with the image 208. The embedding model(s) 106 may then continue to perform these processes to generate additional embeddings 204(N) associated with one or more additional sources of contextual information represented by additional contextual data, where the embeddings 204(1)-(N) (also referred to singularly as “embedding 204” or in plural as “embeddings 204”) are then stored in the database(s) 108.

Referring back to the example of FIG. 1, in some examples, the embedding model(s) 106 may process the contextual data 104 before a session associated with the application. This way, the database(s) 108 may include the stored embeddings associated with the contextual data 104, where the database(s) 108 may then be used (e.g., accessed, etc.) during sessions associated with the application to perform one or more of the processes described herein. However, in other examples, the embedding model(s) 106 may process at least a portion of the contextual data 104 during one or more session associated with the application.

The process 100 may include a dialogue engine 110 receiving input data 112 associated with an input. As described herein, the input data 112 may include, but is not limited to, audio data representing speech associated with the input, text data representing text associated with the input, image data representing one or more images depicting the input, and/or any other type of data. Additionally, the input may include, but is not limited to, a query, a request, an instruction, a suggestion, an observation, and/or any other type of input that may be provided with respect to the application. In some examples, the dialogue engine 110 may then process the input data 112 in order to generate a textual input that represents the input, where the textual input may be represented by text data 114. For a first example, if the input data 112 includes audio data representing user speech corresponding to a query from the user, then the dialogue engine 110 may generate a textual input that represents one or more words from the query. For a second example, if the input data 112 includes text data representing text corresponding to a request input by the user, then the dialogue engine 110 may generate a textual input that represents one or more words from the inputted text. For a third example, if the input data 112 includes visual data representing user speech corresponding to a query from the user, then the dialogue engine 110 may generate a textual input that represents one or more words from the query.

In some examples, the process 100 may also include the dialogue engine 110 receiving additional contextual data 116A associated with the application. For instance, such as during a session between an application server(s) (e.g., an application server(s) 1102) and a client device (e.g., a client device 1104), the application server(s) may be receiving input data representing one or more inputs received by the client device via one or more input devices. The application server(s) may then use the input data to update one or more states associated with the application. For instance, if the application includes a gaming application, then the application server(s) may move a user's character within a gaming environment based at least on the input(s). Additionally, the application server(s) may send, to the client device, content data representing the states of the application. As described herein, the content data may include, but is not limited to, image data representing one or more images, audio data representing sound, and/or any other type of content data.

As such, the dialogue engine 110 may receive the contextual data 116A that includes at least a portion of the content data being generated by the application server(s) and/or presented by the client device. For instance, in some examples, the contextual data 116A may include at least image data representing one or more images generated during the session. In some examples, the dialogue engine 110 may then provide at least a portion of the text data 114 and/or at least a portion of the contextual data 116A to the processing component(s) 102 and/or the embedding model(s) 106 for processing, similar to the contextual data 104. For instance, the embedding model(s) 106 may generate one or more additional embeddings using at least a portion of the text data 114 and/or generate one or more additional embeddings using at least a portion of the contextual data 116A. In other words, the process 100 may continue to update the database(s) 108 with additional embeddings during the session associated with the application.

The process 100 may then include the dialogue engine 110 (and/or another engine, module, device, system, component, and/or the like) using the text data 114 and/or contextual data 116B (which may include at least a portion of the contextual data 116A) in order to identify information related to the input from the user. As described herein, in some examples, to identify the information, the dialogue engine 110 may use the embedding model(s) 106 to generate one or more embeddings (also referred to as “one or more search embeddings”) based at least on the text data 114 and/or the contextual data 116B. For instance, the search embedding(s) may include one or more textual embeddings, one or more image embeddings, and/or any other type of embedding. The dialogue engine 110 may then use the search embedding(s) to search through the database(s) 108 in order to identify one or more stored embeddings that are at least partially related to the search embedding(s).

In some examples, the dialogue engine 110 may use any type of technique to perform the search. For example, when performing the search, the dialogue engine 110 may identify one or more stored embeddings that are related (e.g., closest) to the search embedding(s), such as based on one or more dot products between the embeddings. Other similarity measures, such as cosine similarity and Euclidean distance, may be used to identify those stored embeddings that are related (e.g., closest) to the search embedding(s) In some examples, when performing the search, the dialogue engine 110 may identify a threshold number of embeddings, such as one embedding, two embeddings, five embeddings, ten embeddings, fifty embeddings, and/or any other number of embeddings. While these are just a few example techniques of how the dialogue engine 110 may perform the search, in other examples, the dialogue engine 110 may use one or more additional and/or alternative techniques.

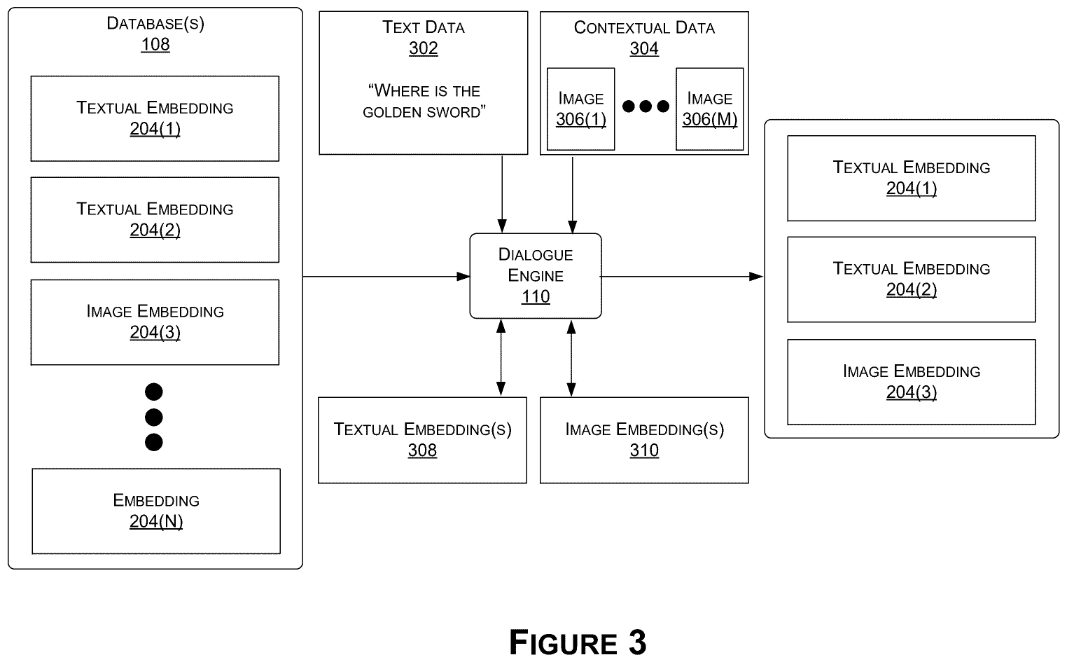

For instance, FIG. 3 illustrates an example of searching through one or more databases in order to identify embeddings that are related to an input, in accordance with some embodiments of the present disclosure. As shown, the dialogue engine 110 may generate and/or receive text data 302 (which may be similar to, and/or represent, text data 114) and contextual data 304 (which may be similar to, and/or represent, contextual data 116B). As shown, the text data 302 may include a textual input, such as a query that includes “Where is the golden sword.” Additionally, the contextual data 304 may represent images 306(1)-(M) corresponding to a session associated with the application. The dialogue engine 110 may then cause one or more textual embeddings 308 that are related to the text data 302 to be generated and/or cause one or more image embeddings 310 that are related to the contextual data 304 to be generated.

Additionally, the dialogue engine 110 may use the textual embedding(s) 308 and/or the image embedding(s) 310 to search through the database(s) 108 in order to identify one or more stored embeddings 204, using one or more of the processes described herein. For instance, in the example of FIG. 3, based at least on the search, the dialogue engine 110 may identify at least the embeddings 204(1)-(3) from embeddings 204(1)-(N), for example, as being the closest the textual embedding(s) 308 and/or image embedding(s) 310. In some examples, and as described herein, by performing such a search, the dialogue engine 110 may be capable of retrieving multimodal outputs given multimodal inputs. For example, the dialogue engine 110 may be configured to retrieve an image given text, text given text, text given an image, an image and text given text, text given an image and text, an image give an image and text, an image and text given an image and text, a time-sequence of images (e.g., a video) given an image and text, a time-sequence of images given an image, a time-sequence of images given text, and/or so forth. In these examples, the text, the image, and/or the time-sequence of images may be associated with the identified embeddings.

Referring back to the example of FIG. 1, the process 100 may include the dialogue engine 110 (and/or another engine, module, device, system, component, and/or the like) filtering at least a portion of the identified embedding(s) and/or contextual information associated with the identified embedding(s) using one or more filters 118, where the filter(s) 118 may be represented by filter data 120. As described herein, the filter(s) 118 may be used to identify contextual information that is more relevant to the input. For a first example, if the identified embeddings include embeddings associated with multiple characters of the application, then the dialogue engine 110 may filter the embeddings using a filter 118 associated with a specific character in order to identify a portion of the embeddings that are related to the specific character. For a second example, if the identified embeddings include embeddings that are associated with multiple levels of the application, then the dialogue engine 110 may filter the embeddings using one or more filters 118 associated with one or more levels (e.g., the current level along with one or more preceding levels) in order to identify a portion of the embeddings that are related to the level(s). Still, for a third example, if the identified embeddings include embeddings that are associated multiple dialogues between the user and a character, then the dialogue engine 110 may filter the embeddings using a filter 118 associated with a current dialogue in order to identify a portion of the embeddings that are related to the current dialogue.

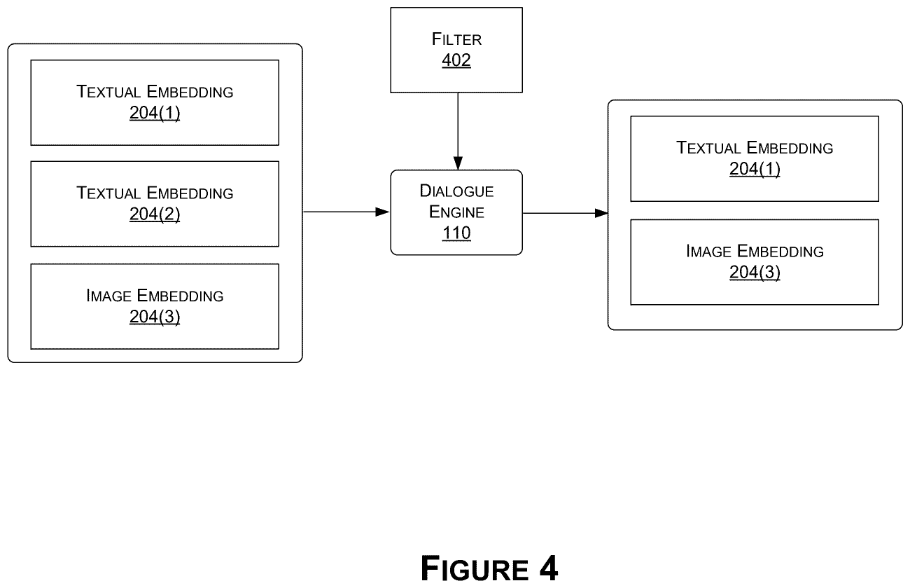

For instance, FIG. 4 illustrates an example of filtering embeddings in order to identify embeddings that are more related to an input, in accordance with some embodiments of the present disclosure. As shown, the dialogue engine 110 may use a filter 402 (which may be similar to, and/or represent, a filter 118) to filter the embeddings 204(1)-(3) initially identified for the input represented by the text data 302. In some examples, the filter 402 may indicate an identifier associated with a character that the user is communicating with, an identifier of a level that the user is on, an identifier of a task that the user is performing, an identifier associated with a current dialogue between the user and the character, and/or any other information. The dialogue engine 110 may then use the filter 402 to remove at least the textual embedding 204(2) from the identified embeddings 204(1)-(3). For example, if the filter 402 indicates an identifier associate with a character, the textual embedding 204(1) may be associated with textual information corresponding to the character while the textual embedding 204(2) may be associated with textual information corresponding to another character. As such, the dialogue engine 110 may filter out the textual embedding 204(2) since it is less relevant for the dialogue.

Referring back to the example of FIG. 1, the process 100 may include one or more prompt component(s) 122 receiving at least the text data 114 representing the textual input (e.g., the query) along with additional text data 124 representing textual information associated with at least a portion of the identified embedding(s). For example, the text data 124 may represent one or more sources of textual information, such as one or more documents, guides, walkthroughs, descriptions, articles, and/or any other type of textual source that includes contextual information associated with the application. The process 100 may then include the prompt component(s) 122 using at least a portion of the text data 114 and/or at least a portion of the text data 124 to generate a prompt, where the prompt may be represented by prompt data 126. As described herein, the prompt component(s) 122 may use any technique to generate the prompt using the at least the portion of the text data 114 and/or the at least the portion of the text data 124.

For a first example, the prompt component(s) 122 may generate a prompt that includes at least a portion of the textual input represented by the text data 114 followed by at least a portion of the text represented by the text data 124. For a second example, the prompt component(s) 122 may generate a prompt that includes at least a portion of the text represented by the text data 124 followed by at least a portion of the textual input represented by the text data 114. Still, for a third example, since the text data 124 may represent text from multiple sources, when generating the prompt, the prompt component(s) 122 may determine an order to arrange the text from the sources. For instance, the prompt may include first text from a first source, followed by second text from a second source, followed by third text from a third source, and/or so forth.

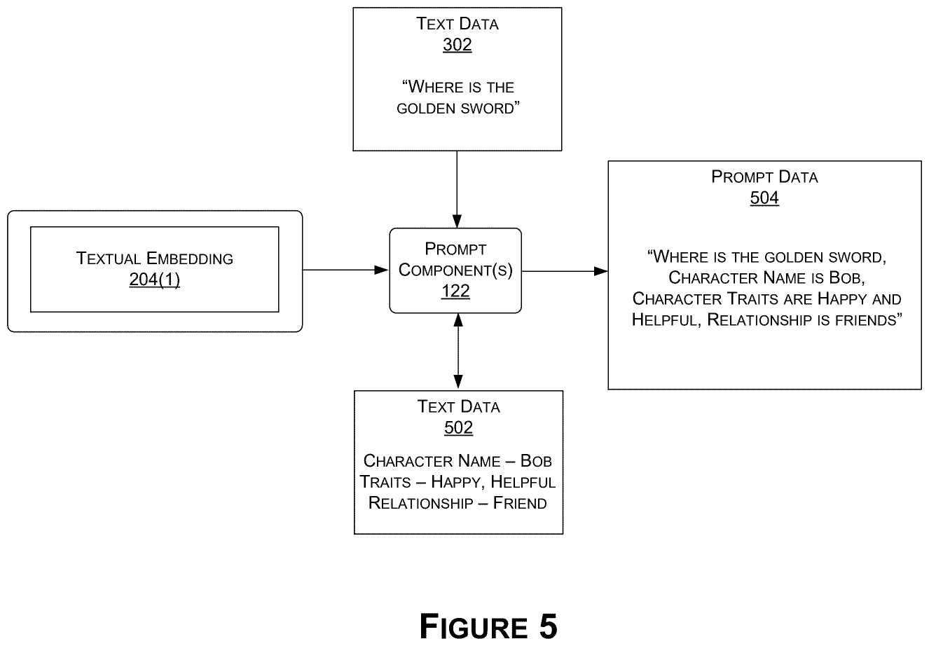

For instance, FIG. 5 illustrates an example of generating a prompt using an input and textual information from one or more sources, in accordance with some embodiments of the present disclosure. As shown, the prompt component(s) 122 may obtain the text data 302 representing the textual input from the user (e.g., the query from the user) and text data 502 representing textual information associated with the textual embedding 204(1). For instance, the text data 502 may represent a document that includes information associated with the character that is to respond to the query, such as the character's name is Bob, the character's traits include happy and helpful, and the character's relationship with the user's character is friend. The prompt component(s) 122 may then use the text data 302 and the text data 502 to generate prompt data 504 (which may be similar to, and/or represent, the prompt data 126) representing a prompt, where the prompt includes the text represented by the text data 302 followed by the text represented by the text data 502.

While the example of FIG. 5 only illustrates the prompt component(s) 122 using the text data 502 that represents a single source of information associated with the character, in other examples, the prompt component(s) 122 may additionally and/or alternatively use additional text data representing one or more additional sources of information. For instance, and with regard to the example of FIG. 5, the prompt component(s) 122 may use text data representing one or more sources of information that describe the golden sword, describe one or more possible locations of the golden sword, describe a map, and/or so forth.

Referring back to the example of FIG. 1, the process 100 may include one or more adapter components 128 receiving one or more image embeddings 130 identified using the dialogue engine 110 (e.g., after filtering). As described herein, the adapter component(s) 128 may include, but is not limited to, one or more machine learning models, one or more neural networks, one or more algorithms, one or more modules, one or more instances of software, and/or any other type of component that is configured to perform one or more of the processes described herein. For example, the adapter component(s) 128 may include and/or use one or more models with one or more transformer stacks, where a respective transformer stack includes a number of layers. As described herein, the number of layers may include, but is not limited to, one layer, two layers, five layers, ten layers, fifty layers, one hundred layers, one thousand layers, and/or any other number of layers.

The process 100 may then include the adapter component(s) 128 processing the image embedding(s) 130 and, based at least on the processing, retrieving and/or generating one or more textual embeddings 132 associated with the image embedding(s) 130. As described herein, the adapter component(s) 128 may use any technique to retrieve and/or generate the textual embedding(s) 132 using the image embedding(s) 130. For a first example, such as during a training process described in more detail herein, the adapter component(s) 128 may learn mappings between image embeddings and textual embeddings. As such, the adapter component(s) 128 may use the learned mappings to retrieve the textual embedding(s) 132 that is associated with the image embedding(s) 130.

For a second example, rather than receiving the image embedding(s) 130, the adapter component(s) 128 may receive the image(s) that is associated with the image embedding(s) 130. The adapter component(s) 128 may then process the image(s) and, based at least on the processing, generate the textual embedding(s) 132 associated with the image(s). While these are just a few example techniques of how the adapter component(s) 128 may retrieve and/or generate the textual embedding(s) 132 using the image embedding(s) 130, in other examples, the adapter component(s) 128 may use one or more additional and/or alternative techniques to retrieve and/or generate the textual embedding(s) 132 using the image embedding(s) 130.

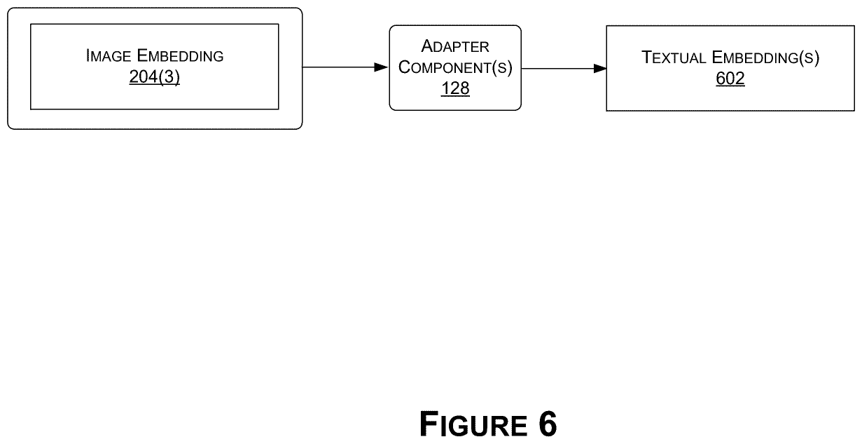

For instance, FIG. 6 illustrates an example of determining one or more textual embeddings that are associated with one or more image embeddings, in accordance with some embodiments of the present disclosure. As shown, the adapter component(s) 128 may receive the image embedding 204(3) that was identified as being related to the text data 302. The adapter component(s) 128 may then perform one or more of the processes described herein to retrieve and/or generate one or more textual embeddings 602 that are associated with the image embedding 204(3). For example, the adapter component(s) 128 may use a mapping between the image embedding 204(3) and the textual embedding(s) 602 in order to retrieve the textual embedding(s) 602.

Referring back to the example of FIG. 1, the process 100 may include applying at least a portion of the prompt data 126 and/or at least a portion of the textual embedding(s) 132 as input data to one or more language model 134. As described herein, in some examples, the language model(s) 134 may include any type of language model, such as one or more neural network based language models (e.g., based on recurrent neural networks, gated recurrent units, etc.), one or more transformer language models, one or more large language models, and/or any other type of language model. In some examples, at least a portion of the prompt data 126 and/or the textual embedding(s) 132 may be processed before applying to the language model(s) 134. For example, the prompt data 126 and/or the textual embedding(s) 132 may be processed in order to generate tokens that represent the text from the prompt data 126 and/or the text associated with the textual embedding(s) 132. The tokens may then be input into the language model(s) 134 as input data. However, in other examples, the language model(s) 134 may be configured to perform this processing of generating the tokens.

The process 100 may then include the language model(s) 134 processing the input data and, based at least on the processing, generating output data 136. As described herein, in some examples, the output data 136 may represent a textual output that is associated with the textual input represented by the text data 114. For example, if the text data 114 represents a query from the user, then the output data 136 may represent a response to the query. As such, in some examples, the textual output may represent one or more characters, punctuation marks, words, sentences, paragraphs, and/or the like associated with the textual output. In some examples, the output data 136 may represent the textual output using one or more techniques, such as using one or more output tokens that may then be converted to generate the textual output. In some examples, the output data 136 may represent additional information associated with speech that is to be output. For instance, in some examples, the character that is to output the speech may also be configured to display emotion while outputting the speech. As such, the output data 136 may further represent information associated with the emotion that the character is to display when outputting the speech.

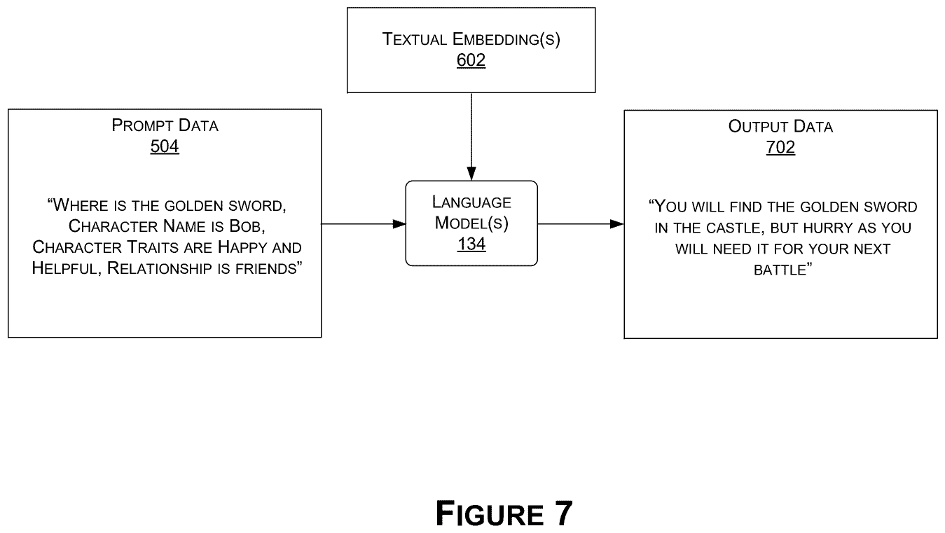

For instance, FIG. 7 illustrates an example of using one or more language models to generate an output, in accordance with some embodiments of the present disclosure. As shown, the language model(s) 134 may receive, as input data, at least the prompt data 504 and the textual embedding(s) 602. The language model(s) 134 may then process the input data and, based at least on the processing, generate output data 702 (which may be similar to, and/or represent, the output data 136). In the example of FIG. 7, the output data 702 may represent text indicating that the location of the golden sword is in the castle. Additionally, such as based on processing the additional contextual information associated with the application, the output data 702 may further represent text indicating that the golden sword will be needed for a next battle. For instance, the contextual information may have indicated that the user was previously involved in a battle before the dialogue started with the character.

Referring back to the example of FIG. 1, the process 100 may include the dialogue engine 110 using the output data 136 to generate audio data 138 representing speech, where the speech includes at least the one or more words represented by the output data 136. For instance, the dialogue engine 110 may include and/or use one or more machine learning models, one or more neural networks, one or more algorithms, one or more tables, and/or any other service, tool, and/or technique to perform one or more of the processes described herein with respect to the dialogue engine 110. For example, the dialogue engine 110 may include a text-to-speech (TTS) service and/or model that is configured to generate the audio data 138 based at least on the output data 136. In some implementations, the output data 136 may be output in other forms such as visually in, for example, a dialogue box of the gaming environment.

As shown, the process 100 may then include causing a character 140 to output the speech represented by the audio data 138. For instance, during the session, the application server(s) may send, to the client device, the content data associated with the state of the application. As described herein, the content data may include at least image data representing one or more images and/or audio data representing sound, such as the audio data 138. As such, the client device may use the content data to present at least the image(s) of the character 140 while also outputting the sound represented by the audio data 138.

In some examples, the process 100 may then continue to repeat as the user and/or the user's character continues to communicate with the character 140. For example, during the dialogue, the process 100 may continue to repeat in order to continue generating additional audio data 138 representing one or more additional textual outputs (e.g., responses) associated with one or more additional textual inputs (e.g., queries). As described herein, by performing the process 100 to generate the textual outputs, the character 140 may seem more human-like during the conversation since textual outputs may be more relevant to the actual state of the application.

As described herein, in some examples, one or more techniques may be used to train at least a portion of the components included in the architecture illustrated in the example of FIG. 1. For instance, in some examples, the language model(s) 134 and/or the embedding model(s) 106 may initially be trained using training input data and/or ground truth data associated with the training input data. In some examples, the training input data and/or the ground truth data may be associated with an application for which the language model(s) 134 and/or the embedding model(s) 106 is being trained. In some examples, the training input data and/or the ground truth data may be associated with different applications such that the language model(s) 134 and/or the embedding model(s) 106 are being trained for use with multiple applications.

The training may also include training the adapter component(s) 128 to perform one or more of the processes described herein. In some examples, the adapter component(s) 128 is trained separately from one or more of the other components. For example, the adapter component(s) 128 may be trained using training input data that is input directly into the adapter component(s) 128, such as training input data representing one or more image embeddings, and ground truth data that is associated with the training input data, such as ground truth data representing one or more textual embeddings associated with the image embedding(s). Additionally, or alternatively, in some examples, the adapter component(s) 128 may be trained within the architecture illustrated by the example of FIG. 1. For instance, the training input data may include textual inputs associated with one or more applications and/or contextual data associated with the application(s) and the ground truth data may include one or more textual outputs associated with the textual input(s).

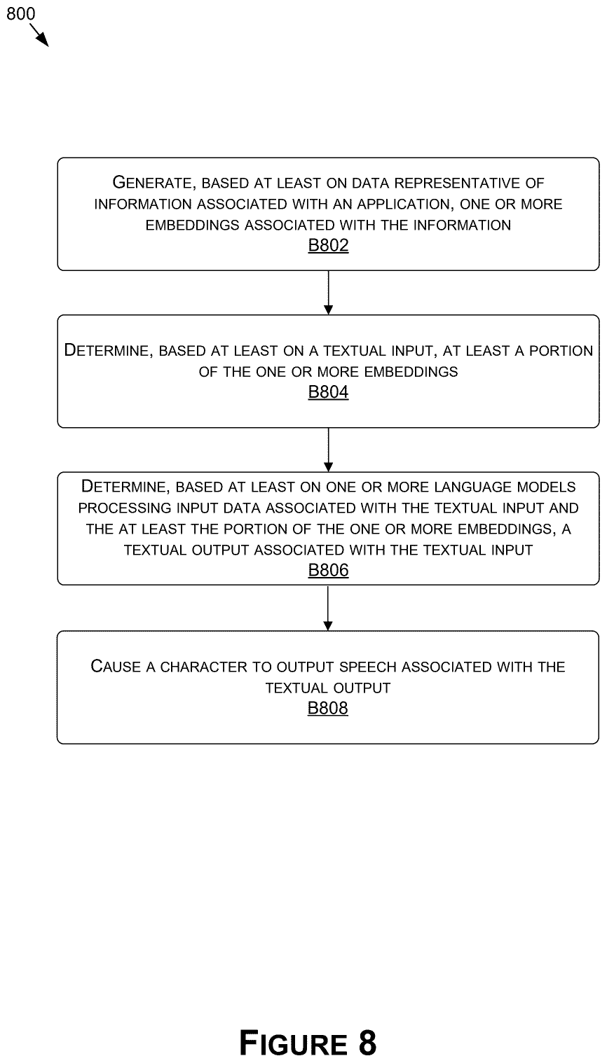

Now referring to FIGS. 8-10, each block of methods 800, 900, and 1000 described herein, comprises a computing process that may be performed using any combination of hardware, firmware, and/or software. For instance, various functions may be carried out by a processor executing instructions stored in memory. The methods 800, 900, and 1000 may also be embodied as computer-usable instructions stored on computer storage media. The methods 800, 900, and 1000 may be provided by a standalone application, a service or hosted service (standalone or in combination with another hosted service), or a plug-in to another product, to name a few. In addition, the methods 800, 900, and 1000 are described, by way of example, with respect to FIG. 1. However, these methods 800, 900, and 1000 may additionally or alternatively be executed by any one system, or any combination of systems, including, but not limited to, those described herein.

FIG. 8 illustrates a flow diagram showing a method 800 for controlling dialogue using contextual information associated with an application, in accordance with some embodiments of the present disclosure. The method 800, at block B802, may include generating, based at least on data representative of information associated with an application, one or more embeddings associated with the information. For instance, the embedding model(s) 106 may process the contextual data 104 and/or the contextual data 116B representing the sources of contextual information associated with the application. As described herein, in some examples, the embedding model(s) 106 may process the contextual data 104 before a session associated with the application, such that the contextual data 104 is general (e.g., applicable, usable, etc.) for multiple sessions, and/or may process the contextual data 116B during the session associated with the application, such that the contextual data 116B is specific to the session. Based at least on the processing, the embedding model(s) 106 may generate the embedding(s), where the embedding(s) is then stored database(s) 108.

The method 800, at block B804, may include determining, based at least on a textual input, at least a portion of the one or more embeddings. For instance, using the text data 114, the dialogue engine 110 may identify the portion of the embedding(s) that is related to the textual input, such as a query. In some examples, the dialogue engine 110 may use additional data to determine the portion of the embedding(s), such as the contextual data 116B associated with the application. Still, in some examples, the dialogue engine 110 may perform additional processing to determine the portion of the embedding(s), such as by filtering the embedding(s) using one or more filters 118. As described herein, in some examples, the portion of the embedding(s) may include one or more textual embeddings, one or more image embeddings, and/or any other type of embedding.

The method 800, at block B806, may include determining, based at least on one or more language models processing input data associated with the textual input and the at least the portion of the one or more embeddings, a textual output associated with the textual input. For instance, in some examples, the prompt component(s) 122 may generate a prompt represented by prompt data 126 using the textual input represented by the text data 114 and/or textual information represented by the text data 124, where the text data 124 may be associated with one or more textual embeddings from the at least the portion of the embeddings. Additionally, in some examples, the adapter component(s) 128 may determine one or more textual embeddings 132 using one or more image embeddings 130 from the at least the portion of the embedding(s). The input data, which may be associated with the prompt data 126 and/or the textual embedding(s) 132, may then be applied to the language model(s) 134. The language model(s) 134 may then process the input data and, based at least on the processing, generate the output data 136 representing the textual output.

The method 800, at block B808, may include causing a character to output speech associated with the textual output. For instance, the dialogue engine 110 may use at least the output data 136 to generate the audio data 138 representing the speech associated with the textual output. The audio data 138 may then be used to cause the character 140 to output the speech. For instance, in some examples, such as when the application server(s) is performing the process 100, the application server(s) may send the audio data 138 to the client device. The client device may then use the audio data 138 to output the speech while also displaying the character 140. In some examples, such as when the client device is performing at least a portion of the process 100, the client device may directly use the audio data 138 to output the speech while also displaying the character 140.

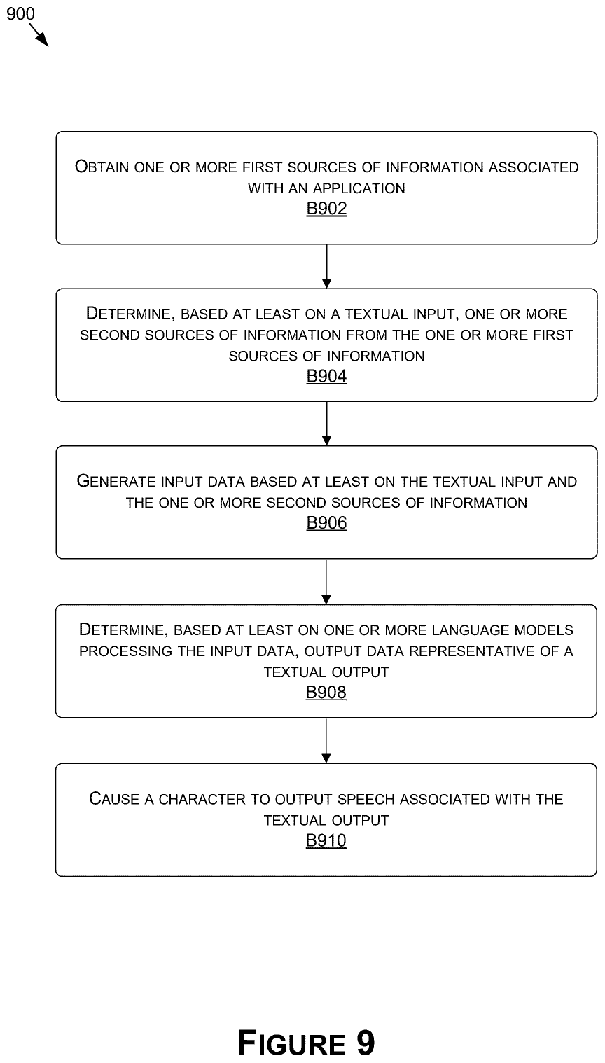

FIG. 9 illustrates a flow diagram showing another method 900 for controlling dialogue using contextual information associated with an application, in accordance with some embodiments of the present disclosure. The method 900, at block B902, may include obtaining one or more first sources of information associated with an application. For instance, the dialogue engine 110 may receive the contextual data 104 representing the first source(s) of information associated with the application. As described herein, the first source(s) of information may include one or more textual sources, one or more images, one or more videos, and/or any other type of source of information. Additionally, in some examples, the dialogue engine 110 may also receive one or more embeddings associated with the first source(s) of information. In some examples, the first source(s) of information may be generated before a session associated with the application and/or during the session associated with the application.

The method 900, at block B904, may include determining, based at least on the textual input, one or more second sources of information from the one or more first sources of information. For instance, the dialogue engine 110 may determine the second source(s) of information using the textual input represented by the text data 114. Additionally, as described herein, in some examples, the dialogue engine 110 may determine the second source(s) of information using the contextual data 116B corresponding to the session associated with the application. In some examples, the dialogue engine 110 may determine the second source(s) of information using the embedding(s). In some examples, the dialogue engine 110 may determine the second source(s) of information using the filter(s) 118.

The method 900, at block B906, may include generating input data based at least on the textual input and the one or more second sources of information. For instance, the dialogue engine 110 (and/or the prompt component(s) 122 and/or the adapter component(s) 128) may generate the input data based at least on the textual input and the second source(s) of information. As described herein, in some examples, the dialogue engine 110 may generate a prompt based at least on the textual input and/or additional text from the second source(s) of information, where at least a portion of the input data represents the prompt. Additionally, or alternatively, in some examples, the dialogue engine 110 may generate the textual embedding(s) 132 using the second source(s) of information (and/or the image embedding(s) associated with the second source(s) of information), where at least a portion of the input data is generated using the textual embedding(s) 132.

The method 900, at block B908, may include determining, based at least on one or more language models processing the input data, output data representative of a textual output. For instance, the dialogue engine 110 may apply the input data to the language model(s) 134. The language model(s) 134 may then process the input data and, based at least on the processing, generate the output data 136 representing the textual output. As described herein, in some examples, the output data 136 may represent additional information, such as information associated with one or more emotional states for a character.

The method 900, at block B910, may include causing a character to output speech associated with the textual output. For instance, the dialogue engine 110 may use at least the output data 136 to generate the audio data 138 representing the speech associated with the textual output. The audio data 138 may then be used to cause the character 140 to output the speech. For instance, in some examples, such as when the application server(s) is performing the process 100, the application server(s) may send the audio data 138 to the client device. The client device may then use the audio data 138 to output the speech while also displaying the character 140. In some examples, such as when the client device is performing at least a portion of the process 100, the client device may directly use the audio data 138 to output the speech while also displaying the character 140.

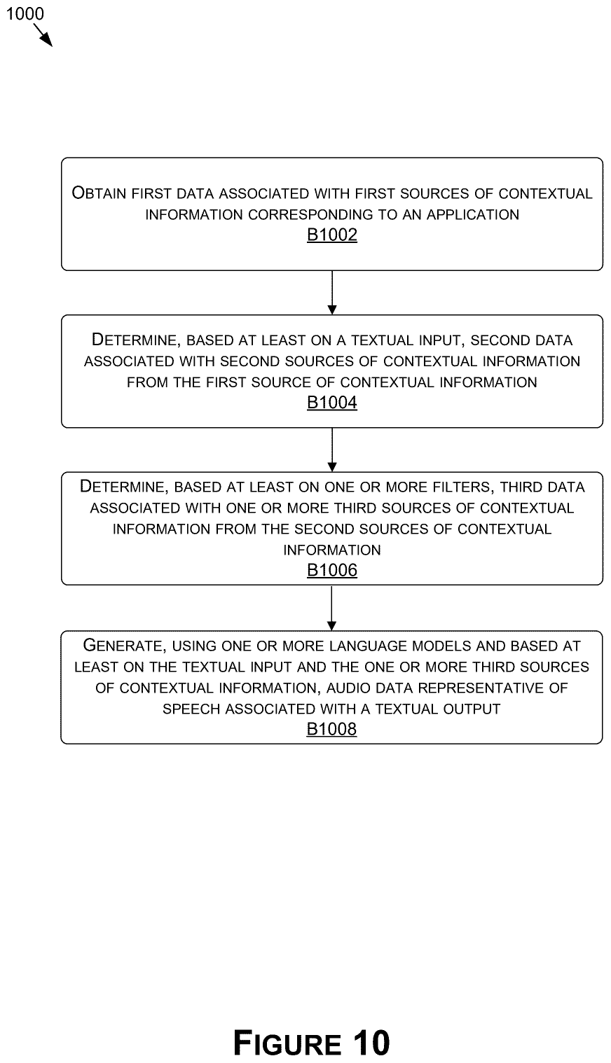

FIG. 10 illustrates a flow diagram showing a method for identifying contextual information for use in generating speech associated with an application, in accordance with some embodiments of the present disclosure. The method 1000, at block B1002, may include obtaining first data associated with first sources of contextual information corresponding to an application. For instance, the dialogue engine 110 may obtain the first data associated with the first sources of contextual information stored in the database(s) 108. As described herein, in some examples, the first data may include embeddings associated with the first sources of contextual information. However, in other examples, the first data may represent the actual first sources of contextual information. Additionally, as described herein, the first sources may include one or more textual sources (e.g., one or more documents, guides, walkthroughs, descriptions, articles, etc.), one or more images, one or more videos, and/or any other source.

The method 1000, at block B1004, may include determining, based at least on a textual input, second data associated with second sources of contextual information from the first sources of contextual information. For instance, the dialogue engine 110 may use at least the textual input to identify the second data associated with the second sources of contextual information. As described herein, in some examples, the dialogue engine 110 may use additional data to identify the second data, such as the contextual data 116B associated with the application.

The method 1000, at block B1006, may include determining, based at least on one or more filters, third data associated with one or more third sources of contextual information from the second sources of contextual information. For instance, the dialogue engine 110 may use the filter(s) 118 to filter the second sources of contextual information in order to identify the third source(s) of contextual information. As described herein, the filter(s) 118 may be associated with a specific character, a specific level, a specific location, a specific dialogue, a specific user, and/or any other aspect of the application. Additionally, the third data associated with the third source(s) of contextual information may include the text data 124, the image embedding(s) 130, and/or other data.

The method 1000, at block B1008, may include generating, using one or more language models and based at least on the textual input and the one or more third sources of contextual information, audio data representative of speech associated with a textual output. For instance, the language model(s) 134 may process data associated with the textual input and/or the third source(s) of contextual information, such as the prompt data 126 associated with the text data 124 and/or the textual embedding(s) 132 associated with the image embedding(s) 130. Based at least on the processing, the language model(s) 134 may generate the output data 136 representing the textual output. The dialogue engine 110 may then use the output data 136 to generate the audio data 138 representing the speech associated with the textual output.

### Example Content Streaming System

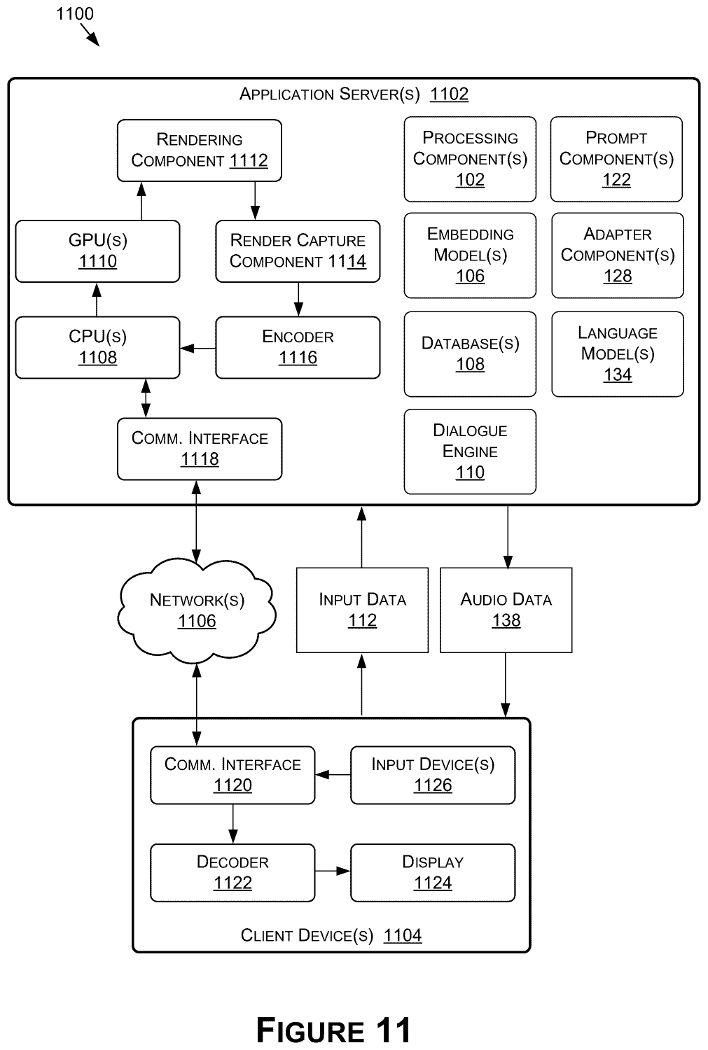

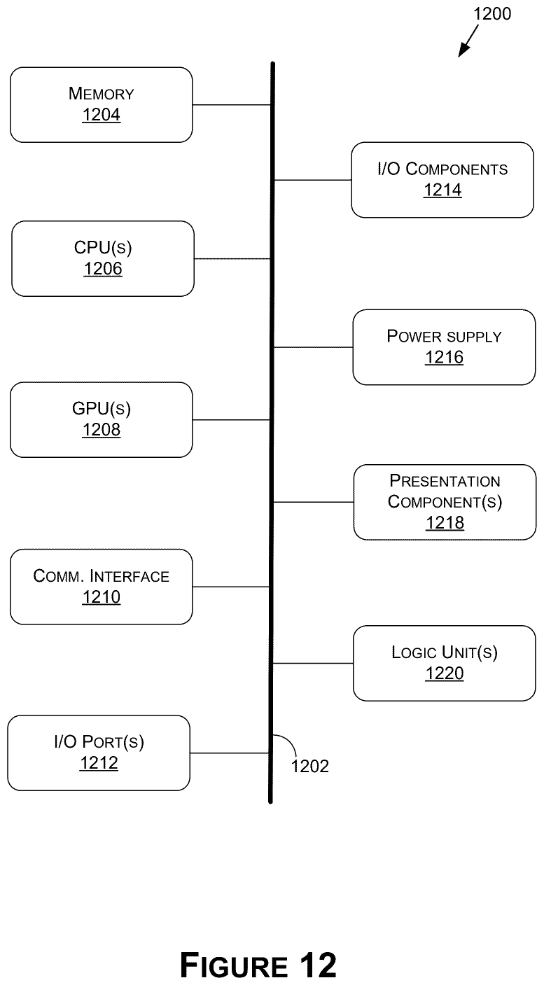

Now referring to FIG. 11, FIG. 11 is an example system diagram for a content streaming system 1100, in accordance with some embodiments of the present disclosure. FIG. 11 includes application server(s) 1102 (which may include similar components, features, and/or functionality to the example computing device 1200 of FIG. 12), client device(s) 1104 (which may include similar components, features, and/or functionality to the example computing device 1200 of FIG. 12), and network(s) 1106 (which may be similar to the network(s) described herein). In some embodiments of the present disclosure, the system 1100 may be implemented. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 1100, for an application session, the client device(s) 1104 may only receive input data in response to inputs to the input device(s), transmit the input data to the application server(s) 1102, receive encoded display data from the application server(s) 1102, and display the display data on the display 1124. As such, the more computationally intense computing and processing is offloaded to the application server(s) 1102 (e.g., rendering—in particular ray or path tracing—for graphical output of the application session is executed by the GPU(s) of the game server(s) 1102). In other words, the application session is streamed to the client device(s) 1104 from the application server(s) 1102, thereby reducing the requirements of the client device(s) 1104 for graphics processing and rendering.

For example, with respect to an instantiation of an application session, a client device 1104 may be displaying a frame of the application session on the display 1124 based on receiving the display data from the application server(s) 1102. The client device 1104 may receive an input to one of the input device(s) and generate input data in response. The client device 1104 may transmit the input data to the application server(s) 1102 via the communication interface 1120 and over the network(s) 1106 (e.g., the Internet), and the application server(s) 1102 may receive the input data via the communication interface 1118. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 1112 may render the application session (e.g., representative of the result of the input data) and the render capture component 1114 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 1102. In some embodiments, one or more virtual machines (VMs)—e.g., including one or more virtual components, such as vGPUs, vCPUs, etc.—may be used by the application server(s) 1102 to support the application sessions. The encoder 1116 may then encode the display data to generate encoded display data and the encoded display data may be transmitted to the client device 1104 over the network(s) 1106 via the communication interface 1118. The client device 1104 may receive the encoded display data via the communication interface 1120 and the decoder 1122 may decode the encoded display data to generate the display data. The client device 1104 may then display the display data via the display 1124.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

As further illustrated by the example of FIG. 11, the application server(s) 1102 may include and/or execute the processing component(s) 102, the embedding model(s) 106, the database(s) 108, the dialogue engine 110, the prompt component(s) 122, the adapter component(s) 128, and/or the language model(s) 134. For instance, the application server(s) 1102 may perform at least a portion of the process 110 described with respect to the example of FIG. 1. However, in other examples, the client device 1104 may include and/or execute the processing component(s) 102, the embedding model(s) 106, the database(s) 108, the dialogue engine 110, the prompt component(s) 122, the adapter component(s) 128, and/or the language model(s) 134.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). In other words, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that enable the computing device 1200 to communicate with other computing devices via an electronic communication network, included wired and/or wireless communications. The communication interface 1210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may enable the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that enable detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to enable the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

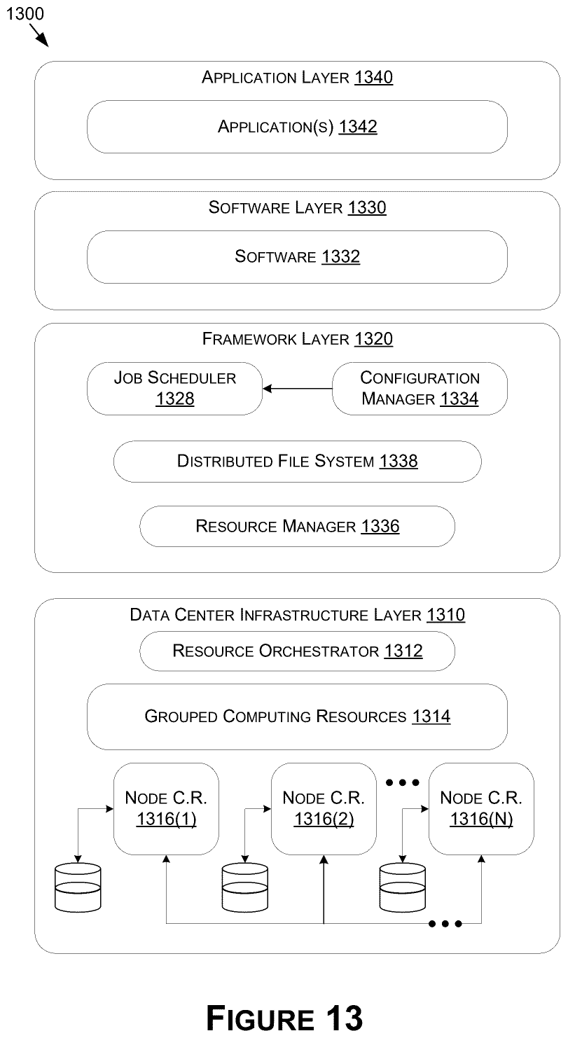

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may utilize distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud- based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, based at least on information associated with an interactive application, one or more embeddings associated with the information; determining, based at least on a textual input, at least a portion of the one or more embeddings; determining, based at least on one or more language models processing input data associated with the textual input and the at least the portion of the one or more embedding, a textual output for the textual input; and causing a character of the interactive application to output speech associated with the textual output.

B: The method of paragraph A, further comprising: determining an identifier associated with the character, wherein the determining the at least the portion of the one or more embeddings is further based at least on the identifier.

C: The method of either paragraph A or paragraph B, further comprising: receiving second input data representative of one or more inputs; and generating, based at least on the second input data, image data representative of one or more images associated with a state of the interactive application, wherein the determining the at least the portion of the one or more embeddings is further based at least on the image data.

D: The method of any one of paragraphs A-C, wherein the information includes one or more of: first information indicating one or more settings associated with the interactive application; second information indicating one or more locations associated with the interactive application; third information indicating one or more tasks associated with the interactive application; fourth information associated with the character; fifth information associated a user of the interactive application; sixth information indicating one or more actions that occurred with respect to the interactive application; seventh information associated with a context for a current state associated with the interactive application; or one or more images corresponding to the interactive application.

E: The method of any one of paragraphs A-D, further comprising: generating one or more second embeddings based at least on at least one of the textual input or one or more images associated with a context of the interactive application, wherein the determining the at least the portion of the one or more embeddings is based at least on comparing the one or more second embeddings with respect to the one or more embeddings.

F: The method of any one of paragraphs A-E, further comprising: determining, based at least on the at least the portion of the one or more embeddings, one or more textual sources that include at least a portion of the information; and generating a prompt based at least the textual input and the one or more textual sources, wherein the input data represents at least the prompt.

G: The method of any one of paragraphs A-F, wherein: the at least the portion of the one or more embeddings includes one or more image embeddings; the method further comprises determining one or more textual embeddings associated with the one or more image embeddings; and the input data is associated with the textual input and the one or more textual embeddings.

H: The method of any one of paragraphs A-G, further comprising: determining one or more filters associated with at least one of the textual input, the character, or the interactive application; and determining, based at least on the one or more filters, at least a second portion of the one or more embeddings from the at least the portion of the one or more embeddings, wherein the input data is associated with the textual input and the at least the second portion of the one or more embeddings.

I: The method of any one of paragraphs A-H, wherein the causing the character of the interactive application to output the speech corresponding to the textual output comprises: generating audio data representative of the speech associated with the textual output; and sending, to a client device, the audio data along with image data representative of one or more images corresponding to at least the character.

J: A system comprising: one or more processors to: determine, based at least on a textual input associated with an application, one or more first sources of information from one or more second sources of information associated with the application; generate input data based at least on the textual input and the one or more first sources of information; determine, based at least on one or more language models processing the input data, a textual output for the textual input; and cause a character of the application to output speech associated with the textual output.

K: The system of paragraph J, wherein the one or more processors are further to: determine an identifier associated with the character, wherein the determination of the one or more first sources of contextual information is further based at least on the identifier.

L: The system of either paragraph J or paragraph K, wherein the one or more processors are further to: receive second input data representative of one or more inputs; and generate, based at least on the second input data, image data representative of one or more images associated with a state of the application, wherein the determination of the one or more first sources of information is further based at least on the image data.

M: The system of any one of paragraphs J-L, wherein the one or more processors are further to: obtain one or more embeddings associated with the one or more second sources of information, wherein the determination of the one or more first sources of information comprises: determining, based at least on the textual input, at least a portion of the one or more embedding; and determining that the one or more first sources of information are associated with the at least the portion of the one or more embeddings.

N: The system of any one of paragraphs J-M, wherein the one or more processors are further to: retrieve text from the one or more first sources of information; and generate a prompt based at least the textual input and the text, wherein the input data represents at least the prompt.

O: The system of any one of paragraphs J-N, wherein: the one or more first sources of information include one or more images associated with the application; the one or more processors are further to determine text based at least on the one or more images; and the input data is associated with the textual input and the text.

P: The system of any one of paragraphs J-O, wherein the one or more processors are further to: determine one or more filters associated with at least one of the textual input, the character, or the application; and determine, based at least on the one or more filters, one or more third sources of information from the one or more first sources of information, wherein the input data is generated based at least on the textual input and the one or more third sources of information.

Q: The system of any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R: One or more processors comprising: processing circuitry to generate a response to a query based at least on one or more language models processing a prompt that is associated with one or more first embeddings and to cause the response to be output perceptually within an interactive application, wherein the one or more first embeddings are identified from one or more second embeddings stored in one or more databases, and wherein the one or more second embeddings are associated with one or more sources that include contextual information associated with the interactive application.

S: The one or more processors of paragraph R, wherein the processing circuitry is further to: generate one or more images associated with a context of the interactive application, wherein the one or more first embeddings are identified based at least on the textual input and the one or more images.

T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, based at least on information associated with an interactive application, one or more embeddings associated with the information;
determining, based at least on a textual input, at least a portion of the one or more embeddings;
determining, based at least on one or more language models processing input data associated with the textual input and the at least the portion of the one or more embedding, a textual output for the textual input; and
causing a character of the interactive application to output speech associated with the textual output.

2. The method of claim 1, further comprising:
determining an identifier associated with the character,
wherein the determining the at least the portion of the one or more embeddings is further based at least on the identifier.

3. The method of claim 1, further comprising:
receiving second input data representative of one or more inputs; and
generating, based at least on the second input data, image data representative of one or more images associated with a state of the interactive application,
wherein the determining the at least the portion of the one or more embeddings is further based at least on the image data.

4. The method of claim 1, wherein the information includes one or more of:
first information indicating one or more settings associated with the interactive application;
second information indicating one or more locations associated with the interactive application;
third information indicating one or more tasks associated with the interactive application;
fourth information associated with the character;
fifth information associated a user of the interactive application;
sixth information indicating one or more actions that occurred with respect to the interactive application;
seventh information associated with a context for a current state associated with the interactive application; or
one or more images corresponding to the interactive application.

5. The method of claim 1, further comprising:
generating one or more second embeddings based at least on at least one of the textual input or one or more images associated with a context of the interactive application,
wherein the determining the at least the portion of the one or more embeddings is based at least on comparing the one or more second embeddings with respect to the one or more embeddings.

6. The method of claim 1, further comprising:
determining, based at least on the at least the portion of the one or more embeddings, one or more textual sources that include at least a portion of the information; and
generating a prompt based at least the textual input and the one or more textual sources,
wherein the input data represents at least the prompt.

7. The method of claim 1, wherein:
the at least the portion of the one or more embeddings includes one or more image embeddings;
the method further comprises determining one or more textual embeddings associated with the one or more image embeddings; and
the input data is associated with the textual input and the one or more textual embeddings.

8. The method of claim 1, further comprising:
determining one or more filters associated with at least one of the textual input, the character, or the interactive application; and
determining, based at least on the one or more filters, at least a second portion of the one or more embeddings from the at least the portion of the one or more embeddings,
wherein the input data is associated with the textual input and the at least the second portion of the one or more embeddings.

9. The method of claim 1, wherein the causing the character of the interactive application to output the speech corresponding to the textual output comprises:
generating audio data representative of the speech associated with the textual output; and
sending, to a client device, the audio data along with image data representative of one or more images corresponding to at least the character.

10. A system comprising:
one or more processors to:
determine, based at least on a textual input associated with an application, one or more first sources of information from one or more second sources of information associated with the application;
generate input data based at least on the textual input and the one or more first sources of information;
determine, based at least on one or more language models processing the input data, a textual output for the textual input; and
cause a character of the application to output speech associated with the textual output.

11. The system of claim 10, wherein the one or more processors are further to:
determine an identifier associated with the character,
wherein the determination of the one or more first sources of contextual information is further based at least on the identifier.

12. The system of claim 10, wherein the one or more processors are further to:
receive second input data representative of one or more inputs; and
generate, based at least on the second input data, image data representative of one or more images associated with a state of the application,
wherein the determination of the one or more first sources of information is further based at least on the image data.

13. The system of claim 10, wherein the one or more processors are further to:
obtain one or more embeddings associated with the one or more second sources of information,
wherein the determination of the one or more first sources of information comprises:
determining, based at least on the textual input, at least a portion of the one or more embedding; and
determining that the one or more first sources of information are associated with the at least the portion of the one or more embeddings.

14. The system of claim 10, wherein the one or more processors are further to:
retrieve text from the one or more first sources of information; and
generate a prompt based at least the textual input and the text,
wherein the input data represents at least the prompt.

15. The system of claim 10, wherein:
the one or more first sources of information include one or more images associated with the application;
the one or more processors are further to determine text based at least on the one or more images; and
the input data is associated with the textual input and the text.

16. The system of claim 10, wherein the one or more processors are further to:
determine one or more filters associated with at least one of the textual input, the character, or the application; and
determine, based at least on the one or more filters, one or more third sources of information from the one or more first sources of information,
wherein the input data is generated based at least on the textual input and the one or more third sources of information.

17. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to generate a response to a query based at least on one or more language models processing a prompt that is associated with one or more first embeddings and to cause the response to be output perceptually within an interactive application, wherein the one or more first embeddings are identified from one or more second embeddings stored in one or more databases, and wherein the one or more second embeddings are associated with one or more sources that include contextual information associated with the interactive application.

19. The one or more processors of claim 18, wherein the processing circuitry is further to:
generate one or more images associated with a context of the interactive application,
wherein the one or more first embeddings are identified based at least on the textual input and the one or more images.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
